(19) United States
(12) Patent Application Publication
(10) Pub. No.: US 2026/0182507 A1
(43) Pub. Date: Jul. 2, 2026

(54) METHOD FOR GENERATING A TREATMENT PLAN SUITABLE FOR DEVELOPING A CULTIVATED AREA WITHOUT CHEMICAL PESTICIDES, METHOD FOR TREATING THE CULTIVATED AREA, AND ASSOCIATED LEARNING MODEL AND SYSTEM

(71) Applicant: MEDINBIO, Wavre (BE)

(72) Inventor: Thierry PICAUD, Bruxelles (BE)

(21) Appl. No.: 18/831,091

(22) PCT Filed: Jan. 5, 2023
(86) PCT No.: PCT/EP2023/050203

§ 371 Date: Aug. 5, 2024

(30) Foreign Application Priority Data
Jan. 5, 2022 (BE) BE20220002
Jan. 5, 2022 (FR) FR2200060

(51) Int. Cl. A01G 24/60; A01N 43/16; A01N 59/06; A01N 59/20; A01N 63/22; A01N 63/38; A01N 65/03; A01N 65/04; A01N 65/08; A01N 65/22; A01N 65/24; A01N 65/28; A01P 21/00

(52) U.S. Cl. CPC A01G 24/60; A01N 43/16; A01N 59/06; A01N 59/20; A01N 63/22; A01N 63/38; A01N 65/03; A01N 65/04; A01N 65/08; A01N 65/22; A01N 65/24; A01N 65/28; A01P 21/00

(57) ABSTRACT

The invention relates to a method for generating (1) a treatment plan adapted for the conditions of development of a cultivated area (S1) as well as an associated system (2). The method (1), as well as the associated system (2), allow to generate treatment recommendations for natural formulations based on environmental parameters on parameters related to the cultivated area and to optimize the development of a cultivated area while eliminating the use of chemical pesticides, more particularly chemical fungicide.

The invention also relates to a method for treating a cultivated area (S1) for a predetermined period of time. The treatment method implements a succession of treatments of the cultivated area (S1) which allow to optimize its development by the combination of natural elicitor, antigerminative and curative formulations at well-determined instants in order to avoid the use of chemical pesticides.

### TECHNICAL FIELD

The invention relates to the field of agriculture, more particularly to the use of data for optimizing the development of a cultivated area without chemical pesticides. In particular, the invention relates to a method for generating a treatment plan suitable for the development of a cultivated area without chemical pesticides.

The invention further relates to a system for monitoring a cultivated area and generating a treatment plan suitable for the development of the cultivated area without chemical pesticides.

The invention further relates to a method for treating a cultivated area for a predetermined period of time, including the implementation of a combination of treatments based on natural formulations of the elicitor, antigerminative and curative type.

The invention also relates to a method for supervised training of a deep learning model for the generation of a treatment plan suitable for the development of a cultivated area without chemical pesticides.

### PRIOR ART

The known prior art from which the invention was developed is described below.

In the field of agriculture, to enable effective control of pests, it is essential to treat crops to ensure optimal development and yield. The development of agriculture in the 20^{th} century was enabled by the advent of agrochemistry. Indeed, the production and massive use of chemical fertilizers and pesticides and the development of intensive agriculture have allowed to respond to one of the major challenges of the 20^{th} century: feeding an ever-increasing world population. The marketing of fertilizers intended to cover the needs of plants associated with wide ranges of very powerful chemical pesticides and having durations of action of several weeks to several months have allowed to significantly increase the production yields of the areas cultivated by boosting the growth of cultivated areas, by allowing the eradication of insects or plants considered harmful or by allowing the treatment of cultivated areas contaminated by pathogens, such as fungi or others. However, at the end of the 20th century, scientists highlighted the deleterious impacts of a large number of synthetic molecules on the one hand on human health and on the other hand on the environment. The deleterious effects of chemical pesticides used, for example Glyphosate or N-(phosphonomethyl)glycine whose exposure considerably increases the risk of non-Hodgkin's lymphoma in humans, or else DTT or DichlorodiphenylTrichloroethane which has a half-life that can exceed 10 years, or more generally organochlorine compounds, synthetic molecules classified as endocrine disruptors have polluted ecosystems for decades. Citizen and political awareness have led to the massive withdrawal of the most problematic substances. For example, 38 substances of concern were withdrawn at European level between 2018 and 2019; France has unilaterally decided to withdraw metam sodium and epoxiconazole.

Although stopping the use of these substances has a positive environmental impact, the field of agriculture risks finding itself without effective tools to optimize the production of cultivated areas and to regulate populations of pests.

Indeed, currently, conventional agriculture is based on a “1 problem=1 solution” type approach. When a pest is identified, a treatment, most often a chemical pesticide, is triggered and it is generally a product containing a specific molecule, targeting the identified pest, which is applied by the farmer to the cultivated area.

Solutions aimed at optimizing crop yield and controlling the population of pests have been developed.

A first solution described in patent application Ser. No. 10/768,156 proposes a system and a method allowing the provision of a predictive yield analysis indicating the impact of various parameters on the yield of a cultivated area. For this purpose, for a given type of crop, it is proposed to determine, from an aggregated crop database, an impact on the yield by one or more yield factors including in particular a variety of seeds used in the cultivated area.

A second solution described in patent application no WO2020132092 proposes a device and a method for predicting the yield of a cultivated area using a predictive framework which is multi-scale, for machine learning and driven by satellite data and data from phenological observations on the ground (crop type, climate/weather data, ground measurements, satellite data for growing conditions and other additional environmental data such as, for example, soil properties of the cultivated area, cultivated area management data, etc.

From the solutions mentioned above, farmers can use this information to make planting choices (for example, seed variety, row spacing, etc.) or post-planting choices (for example, irrigation, application of fertilizers/pesticides etc.).

However, although these solutions allow optimization of crop yield, they are neither adapted to propose a treatment plan based on natural formulations, nor adapted to allow the application of natural formulations, depending on environmental parameters, throughout the plant development cycle of the cultivated area.

Furthermore, the solutions proposed generally include the treatment of cultivated areas with chemical pesticides which have the advantage of combining potency and persistence.

However, the long-term adverse effects on biotopes have justified the gradual cessation of use of the most worrying substances.

Finally, the systemic nature of some of these molecules still used generates the presence of residues of these pesticides in plants, particularly fruits and vegetables, consumed as human or animal food.

### Technical Problem

The invention aims at overcoming the disadvantages of the prior art. In particular, the invention aims at proposing a method and a system for generating a treatment plan adapted for the development of a cultivated area. Such a method and system allow to provide a user with a treatment plan, based on natural formulations, of a cultivated area based on environmental parameters. The application of these natural formulations, depending on the pedoclimatic conditions or else before the appearance or advanced development of pests, allows to strengthen the plant's defense system and promote its growth while ensuring the substitution of chemical products commonly used for the treatment of cultivated areas. The method and the system according to the invention thus allow to generate a treatment plan adapted for the development of the cultivated area and to the environmental conditions thereof, to prevent the appearance or development of pests while eliminating the use of chemical pesticides. The invention further aims at proposing a method for treating a cultivated area for a predetermined period of time involving the implementation of combinations of treatments based on natural formulations of the elicitor, antigerminative and curative type which allow to prevent the appearance or development of pests while eliminating the use of chemical pesticides.

The invention further aims at proposing a method for supervised training of a deep learning model for the generation of a treatment plan adapted for the development of a cultivated area.

### SUMMARY OF THE INVENTION

The invention aims at overcoming these disadvantages.

The invention aims in particular at a method for generating a treatment plan adapted for the conditions of development of a cultivated area including a first natural formulation adapted to promote growth and stimulate the defense system of a plant variety, said method being implemented by a computer device, the generation method comprising the following steps:
loading parameter values of the cultivated area, said parameters comprising at least one plant variety, at least one varietal resistance index associated with the plant variety and a development index of the plant variety,
loading at least one value of an environmental parameter, for a predetermined past period of time, of the cultivated area,
generating a treatment recommendation for the cultivated area according to the value of the environmental parameter and the values of the parameters of the cultivated area, said recommendation including an application of at least one other natural formulation selected from:
   a second natural formulation adapted to stimulate the defense system of the plant variety, and/or
   a third natural formulation adapted to prevent the development of a pest.

The invention allows to optimize the development of a cultivated area while eliminating the use of chemical pesticides, more particularly chemical fungicide. The method according to the invention integrates the difference in action of natural formulations and proposes the use of natural formulations having synergies in their biological mode of action allowing a strengthening of the plant species and optimal effectiveness against the development of a predetermined pest. The complementarity of biological actions between the different potentially usable natural formulations being complex, the invention allows to provide a decision support tool by generating recommendations adapted to the cultivated area and its environmental conditions.

According to other optional characteristics of the method, the latter may optionally include one or more of the following characteristics, alone or in combination:
the step of loading at least one value of an environmental parameter is followed by the steps of:
   determining at least one threshold, for the considered environmental parameter, according to the values of the parameters of the cultivated area,
   comparing the value of the environmental parameter to the at least one determined threshold and selecting the threshold corresponding to the value of the environmental parameter, and
      in which the step of generating the treatment recommendation for the cultivated area depends on the selected threshold.
the parameters of the cultivated area further comprise pedological parameters, nutritional parameters, a prior treatment with a natural formulation and/or a type of irrigation.
the first natural formulation adapted to promote growth and stimulate the defense system of a plant variety is applied by root, and the recommendation of the other natural formulation comprises an application by foliar route.
It further comprises a step of loading at least one value of a forecast environmental parameter, for a predetermined future period of time, of the cultivated area based on geographical coordinates of said cultivated area.
It comprises a step of modifying the recommendation generated based on the prior treatment with a natural formulation and/or the type of irrigation.
the step of modifying the generated recommendation further comprises taking into account the value of the forecast environmental parameter.
the environmental parameter comprises a temperature, a humidity level, a frost risk indicator, a precipitation level, a sunshine level, a wind speed, a detection of a pathogenic organism or a detection of a pathological symptom on the plant variety.
a step of calculating an amount of the other natural formulation to be applied according to the prior treatment with the natural formulation, the parameters of the cultivated area and the value of the environmental parameter.
the first natural formulation comprises microorganisms capable of forming a mutualistic interaction with the plant variety, the second natural formulation comprises at least one elicitor coming from microorganisms, an insect, a nematode or plant fractions or extracts, and/or the third natural formulation comprises at least one active compound having at least one of the following properties: antibacterial, antiviral, insecticidal, insect repellent, antigerminative, nematicidal or antifungal, and when the recommendation comprises the application of the second and third natural formulations, the second natural formulation is applied before the third natural formulation.
the parameters of the cultivated area comprise soil and/or nutritional parameters, said method further comprising a step of comparing at least one value of a soil and/or nutrient parameter to a predetermined threshold and generating a recommendation to add an input when the value of the soil and/or nutrient parameter is not equal to the predetermined threshold.

According to a second object, the invention relates to a system for monitoring a cultivated area and generating a treatment plan adapted for the development of the cultivated area including a first natural formulation adapted to promote growth and stimulate the plant variety defense system, the system comprising a computer device and at least one measuring device, in which:
the measuring device is adapted to measure at least one environmental parameter of the cultivated area,
the computer device is configured to:
   load parameter values of the cultivated area, said parameters comprising at least one plant variety, at least one varietal resistance index associated with the plant variety and a development index of the plant variety,
   load at least one value of an environmental parameter, for a predetermined past period of time, from the cultivated area,
   generate a treatment recommendation for the cultivated area according to the value of the environmental parameter and the values of the parameters of the cultivated area, said recommendation including an application of at least one other natural formulation selected from:
      a second natural formulation adapted to stimulate the defense system of the plant variety, and/or
      a third natural formulation adapted to prevent the development of a pest.

Depending on other optional system features, the computer device may be configured to:
determine at least one threshold, for the considered environmental parameter, according to the values of the parameters of the cultivated area,
compare the value of the environmental parameter to the at least one determined threshold and select the threshold corresponding to the value of the environmental parameter,
   and to generate the treatment recommendation of the cultivated area based on the selected threshold.

According to a third object, the invention relates to a method for treating a cultivated area during a predetermined period of time, said method including:
a first treatment of the cultivated area at a first instant of the predetermined period of time, said first treatment including at least one root and/or foliar application of a natural formulation comprising an agent that elicits defense reactions; said first treatment being carried out at least twice at least 5 days apart;
a second treatment of the cultivated area, at a second instant of the predetermined period of time, said second treatment including the application of a natural formulation comprising an antigerminative, the natural formulation comprising an antigerminative being applied less than two days before the occurrence of a forecast precipitation episode if the forecast precipitation level is greater than a predetermined threshold,
a third treatment of the cultivated area at a third instant of the predetermined period of time, said third treatment including the application of a natural formulation comprising a curative agent, the natural formulation comprising a curative agent being applied less than two days after the end of the forecast precipitation episode.

Such a method allows to optimize the development of a cultivated area while eliminating the use of chemical pesticides, more particularly chemical fungicide. The method according to the invention integrates complementary modes of action of natural formulations and proposes the use of natural formulations having synergies in their biological mode of action allowing a strengthening of the plant species and optimal effectiveness against a predetermined pest.

According to other optional characteristics of the method, the latter may optionally include one or more of the following characteristics, alone or in combination:
a step of controlling the soil of the cultivated area, the control step comprises the measurement of the following parameters: a cation exchange capacity, a hydrogen potential, an organic matter content, a carbon to nitrogen mass ratio and a microbial biomass content, the first, second and third treatments being implemented if the values of said measured parameters meet respective predetermined criteria.
the first, second and third treatments do not comprise systemic chemical compounds.
the natural formulation of the first treatment comprises at least one agent that elicits defense reactions selected from: a plant extract adapted to induce elicitation at a predetermined concentration, an animal extract adapted to induce elicitation, an algae extract adapted to induce elicitation at a predetermined concentration, a microorganism adapted to induce elicitation or combinations thereof.
the plant extract is a horsetail extract or nettle extract or a combination thereof.
the animal extract is chitosan.
the microorganism adapted for inducing elicitation is selected from the genus Trichoderma, the genus Bacillus or combinations thereof.
the natural formulation of the second treatment comprises at least one antigerminative selected from: a copper-based composition, a mineral substance, an essential oil adapted to induce an antigerminative effect at a predetermined concentration, or combinations thereof.
the mineral substance is talc, kaolin, lithothamne, or combinations thereof.
the antigerminative is an essential oil selected from an essential oil of clove, cinnamon, flowering plants of the tea tree genus, mint, eucalyptus, thyme, oregano or combinations thereof.
the natural formulation of the third treatment comprises at least one curative agent, preferably a natural fungicide, selected from: an essential oil adapted to induce a curative effect at a predetermined concentration, a hydroalcoholic extract of algae or combinations thereof
the curative agent is selected from an essential oil of clove, cinnamon, eucalyptus, thyme or combinations thereof.
the curative agent is a hydroalcoholic extract of red algae.
the curative agent comprises a microorganism of the genus Bacillus.

According to a fourth object, the invention relates to a machine learning model trained to predict a treatment plan adapted for the conditions of development of a cultivated area including a first natural formulation adapted to promote growth and stimulate the defense system of a plant variety, the trained machine learning model being obtained according to the following steps:
acquiring, at each of the acquisition instants of a plurality of successive acquisition instants, reference parameter values of a plurality of reference cultivated areas, the reference parameters comprising, for each reference cultivated area, at least:
   parameter values of the cultivated area, the parameters of the cultivated area including a plant variety, a varietal resistance index associated with the plant variety, a development index of the plant variety,
   a value of an environmental parameter,
   treatment data including at least one other natural formulation selected from a second natural formulation adapted to stimulate the defense system of the plant variety, and/or a third natural formulation adapted to prevent the development of a pest, and
   data on the effectiveness of the treatment with the at least one other natural formulation,
calculating, at each acquisition instant, for each of the plurality of reference cultivated areas, mathematical quantities, from the values of the parameters of the cultivated area, the value of the associated environmental parameter, acquired at acquisition instants included in a predetermined period of time preceding the current acquisition instant,
creating, for each of the plurality of reference cultivated areas, a mathematical reference function from the parameter values of the cultivated area, the value of the environmental parameter and the mathematical quantities,
associating, at each acquisition instant, for each of the plurality of reference cultivated areas, the reference mathematical function with the efficiency data of the treatment of the reference cultivated area, so as to obtain variables of the machine learning model, and
training a machine learning model to predict a treatment plan including at least one other natural formulation, based on a machine learning algorithm and machine learning model variables.

### BRIEF DESCRIPTION OF THE DRAWINGS

Other characteristics and advantages of the invention will be better understood upon reading the description which follows and with reference to the appended drawings, given by way of illustration and in a non-limiting manner.

FIG. 1 shows an embodiment of a method for generating a treatment plan according to the invention.

FIG. 2 illustrate the level of protection obtained from individual and combined treatments. In particular:

FIG. 2A the level of protection obtained from a first treatment including at least one root and/or foliar application of a natural formulation comprising an eliciting agent;

FIG. 2B the level of protection obtained from a second treatment including the application of a natural formulation comprising an antigerminative;

FIG. 2C the level of protection obtained from a third treatment including the application of a natural formulation comprising a curative agent;

FIG. 2D the level of protection obtained from a treatment plan according to the invention combining one or more of the three treatments.

FIG. 3 shows an embodiment of a system for monitoring a cultivated area and generating a treatment plan according to the invention.

FIG. 4 shows an example of a treatment plan for a cultivated area for a predetermined period of time according to the invention.

FIG. 5A shows a photo of part of a potato harvest of the ‘GOURMANDINE’ variety obtained by following a treatment plan according to the invention.

FIG. 5B shows a photo of part of a potato harvest of the ‘GOURMANDINE’ variety obtained following a conventional treatment plan.

The figures do not necessarily respect scales, particularly in thickness, for illustration purposes.

Aspects of the present invention are described with reference to flow charts and/or block diagrams of methods, systems according to embodiments of the invention.

In the figures, flow charts and block diagrams illustrate the architecture, functionality and operation of possible implementations of systems and methods according to various embodiments of the present invention. In this regard, each block in the flowcharts or block diagrams may represent a system, device, module or code, which comprises one or more executable instructions to implement the specified logic function(s). In some implementations, the functions associated with the blocks may appear in an order different from that shown in the figures. For example, two blocks shown in succession may, in fact, be executed substantially simultaneously, or the blocks may sometimes be executed in reverse order, depending on the functionality involved. Each block of the block diagrams and/or flowchart, and combinations of blocks in the block diagrams and/or flowchart, may be implemented by special hardware systems that perform the specified functions or acts or perform combinations of special equipment and computer instructions.

### DESCRIPTION OF EMBODIMENTS

Below, a summary of the invention and the associated vocabulary is described before presenting the disadvantages of the prior art, then finally showing in more detail how the invention overcomes them.

In the remainder of the description, the expression “computer device” corresponds to any device comprising a processing unit or a processor, for example in the form of a microcontroller cooperating with a data memory, possibly a program memory, said memories that can be dissociated. The processing unit cooperates with said memories via internal communication buses.

By “natural formulation” within the meaning of the invention, it is necessary to understand a formulation comprising one or more chemical compounds or substances which are found in nature, in particular a plant extract, an alga, a microorganism, minerals, preferably produced by a living organism. A natural formulation within the meaning of the invention comprises chemical compounds of natural origin which can also be obtained by chemical synthesis. Thus, a natural formulation within the meaning of the invention has a contact effect but does not have a systemic effect, that is to say that said formulation is not found conveyed in the sap of the plant once applied thereto.

The term “pest” refers to any type of ravager known in the field of agriculture, including insects or worms, any type of plant pathogens, such as fungi or weeds.

“Coupled” in the sense of the invention means connected, directly or indirectly with one or more intermediate elements. Two elements can be coupled mechanically, electrically or linked by a communication channel.

The expression “plant species” defines a group of plants having similar characteristics and capable of breeding with each other, but sterile with any plant of another species. As a non-limiting example, the plant species considered is Solanum tuberosum.

In the remainder of the description, the different characteristics presented and/or claimed can be advantageously combined. Their presence in the description or in different dependent claims does not exclude this possibility.

As has been mentioned, the current observation is that the use of chemical fertilizers and pesticides in agriculture is widespread worldwide. Chemical fertilizers are used to maximize crop yields. Chemical pesticides are, in turn, used to eradicate the presence of pests in crops. Each chemical pesticide used being specifically effective against one or more pests, the development of resistance in cultivated plants to these pests is not a priority.

However, the withdrawal and the desire to limit the use of chemical pesticides leave agricultural professionals without an alternative solution to chemical pesticides.

The substitution of chemical pesticides by natural formulations is possible but the modes of action of the latter are different. Programs composed of natural formulations combine actions that can be powerful/effective but of limited duration while the persistence of natural formulations with direct action, that is to say targeting a pest, is limited but indirect persistence is possible via elicitation mechanisms. Furthermore, the use of natural substances compared to chemical pesticides allows the absence of non-biodegradable residues on the external parts of the plant, the persistence of natural protection related to the stimulation of natural defenses is related to the persistence of endogenous compounds in the plant cells and not to the compounds that allowed this external stimulation.

Although the substitution of chemical pesticides by natural formulations remains possible, managing the application of natural formulations is much more complex and requires choosing the right natural formulation and applying it at the right time in order to obtain a protection that is equivalent to that obtained with chemical pesticides.

Active ingredients of natural origin most often have a contact action which allows to benefit from an instantaneous effect but do not offer persistence to protect against a health risk in the long term. As a result, farmers engaged in organic farming most often use disease-resistant varieties which do not have the same yield potential as conventional varieties and thus resort, often excessively, to copper for its antigerminative effect on fungal spores. The use of copper in combination with resistant varieties constitutes the basis of organic agriculture but does not allow to achieve production yields of conventional varieties and, therefore, appears limiting in replacing the current agricultural model based on the use of chemical pesticides.

Faced with these observations, the invention proposes the generation of a treatment plan, based on natural formulations, comprising one or more recommendations for treating a cultivated area, based on parameters related to the cultivated area and its environment. Indeed, the different stages of development of a cultivated plant imply different needs, whether in the context of their growth, or resistance to climatic conditions and pests. Although the use of chemical fertilizers and pesticides makes it easy to meet the needs associated with the different stages of development of a cultivated plant, the use of alternatives based on natural formulations requires a more detailed analysis of environmental parameters in order to continually adapt the application of natural formulations according to said parameters and thus allow to optimize the resistance of the cultivated plant according to the type of attacks to which it could be subjected.

Thus, according to a first aspect, the invention relates to a method for generating a treatment plan adapted for the development of a cultivated area including a first natural formulation adapted to promote growth and stimulate the defense system of a species plant, the method comprising a step of loading parameter values of the cultivated area, a step of loading at least one value of an environmental parameter and a step of generating a treatment recommendation of the cultivated area.

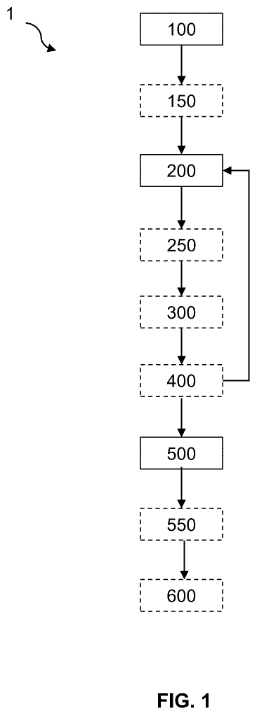

FIG. 1 illustrates an example of a method for generating a treatment plan 1 according to the invention implemented by a computer device.

As mentioned previously, the invention includes a step 100 of loading the parameter values of the cultivated area.

The parameters of the cultivated area comprise at least one plant variety, at least one varietal resistance index associated with the plant variety and at least one development index of the plant variety.

A plant variety corresponds to a set of plants identified by morphological, physiological and genetic characteristics which distinguish it from other plants of the same species. As a non-limiting example, the plant variety considered is the Allians variety.

Furthermore, the cultivated area parameters include one or more varietal resistance indices associated with the plant variety. Each varietal resistance index can, for example, describe the overall resistance of the variety of the plant species considered or describe the level of resistance of the plant variety in relation to a given environmental parameter, examples of which will be presented later. As illustrative examples, the varietal resistance index can correspond to a value approximated to the unit ranging from 1 to 10, reflecting sensitivity to diseases, ravagers and/or physiological accidents, a value ranging from 7 to 10 describing a plant variety called “resistant” plant variety, a value ranging from 5 to 6 describing a plant variety called “semi-resistant” plant variety or a value ranging from 1 to 4 describing a plant variety called “sensitive” plant variety for a given environmental parameter. Thus, the closer the varietal resistance index is to 1, the more the corresponding variety has a high sensitivity with regard to the considered environmental parameter. A high sensitivity generally indicates that the variety is unlikely to survive, in the event of the development of a pest, without the application of a chemical pesticide.

In addition, the cultivated area parameters comprise a plant variety development index. The plant variety development index can correspond to a value describing the phenological stage of the plant variety of the cultivated area. As non-limiting examples, the development index of the cultivated area can take the value “1” to describe the germination of the plant variety, the value “2” to describe the growth phase of the plant variety once emerged from the ground until the start of senescence, the value “3” to describe the phase going from the start of senescence until the time of harvest of the plant variety and/or its fruits.

In order to facilitate the association of the development index of the plant variety with a step of development of the plant variety, the development index of the plant variety can take the value “1” during a time interval of up to four weeks once the seeds have been sown, the value “2” for a time interval of four weeks to eight weeks once the seeds have been sown, the value “3” for a time interval of eight weeks to twelve weeks once the seeds have been sown. On the other hand, depending on the plant variety considered, said time intervals will be likely to vary so that they correspond to the phenological stages described above.

In another embodiment, the development index of the cultivated area can take a value describing a stage of the BBCH (for Biologische Bundesanstalt, Bundessortenamt und CHemische Industrie according to German terminology) code. Thus, the development index can take the value “0” to describe the germination of the plant variety, the value “1” to describe the development of the leaves, the value “2” to describe the formation of secondary shoots/tillering, the value “3” to describe the elongation of the stem/the formation of the rosette/the development of the shoots, the value “4” to describe the formation of the vegetative parts of the harvest or the organs of vegetative multiplication/development of the organs of sexual reproduction, swelling of the ear or panicle, the value “5” to describe the appearance of the inflorescence, the value “6” to describe flowering, the value “7” to describe the development of the fruits, the value “8” to describe the ripening of the fruits, the value “9” to describe the phase going from the start of senescence until the time of harvest of the plant variety and/or its fruits.

As resistance to certain environmental conditions or to certain pests can vary during the different phenological stages of the plant variety, the varietal resistance index, in relation to a given environmental parameter, can also be associated with the development index of the plant variety. Indeed, the plant variety may be sensitive to certain types of pests during the germination phase and not during the senescence phase and vice versa. Furthermore, during the development of the plant variety, certain agricultural practices, such as mound closure, may complicate the application of natural formulations and may justify the application of these formulations during an earlier phenological stage for allowing the development of the defense system of the plant variety. Likewise, when the senescence phase of the plant variety begins, the application of certain natural formulations, in particular those comprising an elicitor, no longer has any interest in the context of prevention against certain types of pests. Indeed, the stimulation of plant defense systems becomes ineffective once the plant enters the senescence phase.

In one embodiment of the generation method according to the invention, the parameters of the cultivated area may comprise geographic coordinates which allow to locate the cultivated area.

In another embodiment of the generation method according to the invention, the latter may comprise a step 150 of comparing at least one value of a soil and/or nutritional parameter to a predetermined threshold and generating a recommendation of addition of an input when the value of the soil and/or nutrient parameter is not equal to the predetermined threshold.

Advantageously, the input can correspond to any type of materials of known type intended to improve/modify the soil parameters of the cultivated area. The recommended input may comprise a composition adapted to modify the soil and/or nutrient parameters of the cultivated area so that the value of the soil and/or nutrient parameter is equal to the predetermined threshold.

For example, the input may comprise Vinasse, a hydrolyzate of fish proteins and marine algae extracts, trace elements and magnesium sulfate, organic Nitrogen in the form of Magnesium Oxide and of Sulfur.

Generally speaking, soil parameters describe the condition of the soil of the cultivated area.

Soil parameters may comprise without limitation:
A soil texture. Soil texture can correspond to a ratio between different elements likely to make up the soil of the cultivated area such as clay, silt, sand. In the context of the invention, clay/silt/sand ratios can be defined in order to describe a support suitable for the cultivation of a predetermined plant variety. A suitable support can for example correspond to a clay/silt/sand ratio allowing to avoid anoxia of the soil, that is to say a reduction in the oxygen dissolved or present and bioavailable therein, and a low inertia against abiotic stress.
A hydrogen potential (pH) of the soil. Indeed, a pH adapted for the development of certain microorganisms can prove advantageous in particular for the activity of bacteria responsible for transformations of organic matter, or for earthworms. Depending on the texture of the soil, the pH-water value can range from 6.5 to 8, preferably from 6.8 to 7.5 and even more preferably from 7 to 7.2, this generally allows an optimal development of these microorganisms.
Organic matter content. Indeed, organic matter is a support but also a source of nutrients for the development of communities of microorganisms and the value of the organic matter content can range from 1% to 2.5%, preferably from 1.2% to 2.1%, depending on soil texture.
A carbon to nitrogen mass ratio (C/N). The C/N ratio is an indicator which allows to judge the degree of evolution of organic matter, that is to say its ability to decompose more or less quickly in the soil and ensure optimal development of microorganisms. For example, the C/N ratio can range from 10 to 25.

Alternatively or in addition, the parameters of the cultivated area may comprise nutritional parameters. The nutritional parameters describe the accessibility, by the plant variety, to the elements necessary for optimal elicitation. Without limitation, the nutritional parameters can correspond to a concentration in the soil of the cultivated area of nitrogen, phosphorus and potassium.

Still within the framework of the invention, the method for generating a treatment plan 1 comprises a step 200 of loading at least one value of an environmental parameter, for a predetermined past period of time, of the cultivated area.

By way of non-limiting examples, the environmental parameter may comprise a temperature, a humidity level, for example of the air and/or the foliage of the plant variety, a frost risk indicator, a precipitation level, a sunshine level, a wind speed, a detection of a pathogenic organism and/or a detection of a pathological symptom on the plant variety, for example foliage mildew or else tuber mildew.

The past period of time may correspond to a duration, preferably expressed in days, prior to the moment when the generation method according to the invention is implemented. For example, the past period of time may correspond to a duration of one hour or several hours, one day or several days. The value of the considered environmental parameter can be loaded at regular intervals over the entire duration of the period of time, for example once per hour. The value of the environmental parameter can also correspond to a value averaged from all the values loaded at regular intervals for the considered environmental parameter, such as in particular an average precipitation level over a period of time of three days. The value of the environmental parameter may also correspond to a value indicating or not the detection of an environmental parameter, in particular that of a pathogenic organism or pathological symptoms, due for example to a pest, on the plant variety.

In one embodiment according to the invention, the method may comprise a step of loading at least one value of a forecast environmental parameter 250, for a predetermined future period of time, of the cultivated area from geographical coordinates of said cultivated area.

“Predetermined future period of time” means a duration, like the past period of time, preferably expressed in days, subsequent to the moment when the generation method according to the invention is implemented.

Like the environmental parameter, the forecast environmental parameter may comprise a temperature, a humidity level, for example of the air and/or the foliage of the plant variety, a frost risk indicator, a precipitation level, a sunshine level, a wind speed, a detection of a pathogenic organism and/or a detection of a pathological symptom on the plant variety, for example foliage mildew or else tuber mildew.

In a particular embodiment, the method according to the invention may further comprise a step 300 of determining a threshold, for the considered environmental parameter, according to the parameter values of the cultivated area.

In the context of the invention, threshold means at least one threshold associated with a given environmental parameter. The threshold can be represented by a numerical value or by a range of values forming an interval. Indeed, in the invention it may be advantageous to determine several thresholds for a given environmental parameter in order to be able to generate a recommendation for the application of a natural formulation adapted to the environmental conditions of the cultivated area.

In the context of the invention, it is planned that the parameters of the cultivated area as well as environmental parameters and one or more predetermined thresholds are comprised in a data repository. The values of the environmental parameters considered are for example communicated or loaded by the computer device then encoded in the data repository. Depending on the considered period of time, the value of the environmental parameter encoded in the data repository may correspond to an average of the values of the environmental parameter loaded at regular intervals, for example every hour.

According to one embodiment of the method for generating a treatment plan 1 according to the invention, the latter can comprise a step 400 of comparing the value of the environmental parameter to at least one determined threshold and the selection of the threshold corresponding to the value of the environmental parameter.

For example, depending on the development index of the plant variety and the considered environmental parameter, one or more thresholds can be predetermined. Each threshold can be associated with one or more natural formulations. The value of the considered environmental parameter is compared to the threshold(s) and the threshold comprising the value of the environmental parameter is selected.

Alternatively or in addition, a threshold can take a single value, for example the value “0” or “1”. In this case, the considered environmental parameter may correspond to the detection or not of a pathogenic organism or a pathological symptom on the plant variety, and the value of the environmental parameter may take the value “0” if no pathogenic organism or pathological symptom is detected or the value “1” if a pathogenic organism or pathological symptom is detected. The value of the considered environmental parameter is compared to the threshold(s) and the threshold corresponding to the value of the environmental parameter is selected.

In a particular embodiment, in order to optimize the application of natural formulations and maximize their effects, the parameters of the cultivated area may comprise a prior treatment with a natural formulation according to the invention, for example during a given period of time.

As has already been mentioned, different thresholds can be applied depending on the development of the plant variety, but taking into account certain environmental parameters may remain relevant during the development cycle of the plant variety. However, any application of a natural formulation that is not necessary should be avoided, thus consideration of previous treatments already applied to the cultivated area S1 may be necessary.

Alternatively or in addition, the parameters of the cultivated area can also comprise a type of irrigation. Indeed, depending on water needs, certain cultivated areas may comprise sprinkler irrigation systems, micro-irrigation systems or else drip irrigation or buried drip irrigation systems of known types. Thus, natural formulations can be selected according to the type of irrigation, in particular to facilitate their application to cultivated areas.

Data relating to the type of irrigation can be encoded in the data repository like data related to the development index of the plant variety or the natural formulation applied.

Alternatively, the comparison step 400 can be implemented for a second environmental parameter. In this case, the steps of the method according to the invention are also implemented for the second considered environmental parameter. Thus, the value of the second environmental parameter is compared 400 to a second predetermined threshold. When the values of the first and second environmental parameters correspond respectively to the first and second predetermined thresholds, the next step of the method can be implemented. The person skilled in the art will understand that the application of a natural formulation, in particular with a view to preventing the appearance or development of pests, may require taking into account different environmental parameters. Indeed, certain pests require, in order to develop, very specific environmental parameters to be met, such as a particular level of humidity in the air and a particular ambient temperature. The invention cannot be limited to these environmental parameters; other environmental parameters characterizing the optimal conditions for the development of a pest could be used alone or in combination.

In a particular embodiment of the method according to the invention, when the step 400 of comparing the value of the environmental parameter to the at least one determined threshold does not allow to identify a threshold corresponding to the value of the environmental parameter, the method stops.

Alternatively, when the step 400 of comparing the value of the environmental parameter to the determined threshold does not allow to identify a threshold corresponding to the value of the environmental parameter, a new step of loading at least one value of an environmental parameter 200 is implemented.

When no threshold is identified during the comparison step 400, the new step of loading at least one value of an environmental parameter 200 can be implemented for another environmental parameter. Furthermore, it is provided that the new step of loading at least one value of an environmental parameter 200 is implemented for the same environmental parameter when a new value of the environmental parameter is communicated to the computer device 10.

Finally, a method according to the invention comprises a step 500 of generating a recommendation R1, R2 for treating the cultivated area according to the value of the environmental parameter and the values of the parameters of the cultivated area.

In a particular embodiment of the generation method 1 according to the invention, when the step 200 of loading at least one value of an environmental parameter is followed by the steps of:
determining 300 at least one threshold, for the considered environmental parameter, according to the values of the parameters of the cultivated area,
comparing 400 the value of the environmental parameter with the determined threshold and selecting the threshold corresponding to the value of the environmental parameter,
   the step 500 of generating the recommendation R1, R2 for treating the cultivated area is based on the selected threshold.

Thus, when the threshold is selected, the corresponding natural formulation(s) are encoded in a recommendation R1, R2, for example in the form of a message displayable via a suitable human-machine interface.

On the other hand, it is provided that the method according to the invention can take into consideration other parameters for the generation of a recommendation. The other parameters can for example be another environmental parameter and/or another parameter of the cultivated area.

In a particular embodiment, the method according to the invention may comprise a step of modifying the generated recommendation according to the prior treatment with a natural formulation for a given period of time and/or the type of irrigation.

In a particular embodiment of the recommendation modification step, the generated recommendation further comprises taking into account the value of the forecast environmental parameter.

Indeed, as described previously, the value of the environmental parameter can correspond to an average value of the environmental parameter for a predetermined past period of time. On the other hand, it may be advantageous to take into consideration the evolution of the considered environmental parameter for a future period of time in order to recommend or not the application of one or more natural formulations.

In general, the application of certain natural formulations may be recommended during a more or less intense rainy episode, particularly when the average precipitation level measured exceeds a predetermined threshold, in order to prevent the development of pests. However, the generation of this recommendation may be subject to a value of the forecast average precipitation level and/or to other forecast environmental parameters such as temperature or humidity level for example. Indeed, it will be understood that depending on the development conditions of certain pests, it may be advantageous to take into account the value of an environmental parameter for a past period and for a future period in order to generate or not an application recommendation of one or more natural formulations.

Still within the framework of the invention, the recommendation R1, R2 includes the application of at least one other natural formulation selected from:
a second natural formulation adapted to stimulate the defense system of the plant variety, and/or
a third natural formulation adapted to prevent the development of a pest.

In a preferred embodiment of the method according to the invention, the first natural formulation adapted to promote growth and stimulate the defense system of a plant variety is applied via the root, and the recommendation of the other natural formulation comprises a foliar application.

By way of non-limiting examples, the application via the root can be carried out by coating or dip treating the seeds or via a soil irrigation technique of known types, in particular by micro-irrigation. Furthermore, the recommended foliar application may be an application by spraying, that is to say the projection of a composition in the form of drops, droplets or else an aerosol by a spraying device of known type, a mounted, semi-mounted or self-propelled sprayer towed or dragged by a motorized vehicle such as a tractor for example, but also by aerial spreading, such as by plane or helicopter or else via the use of drones, which are autonomous or not.

In the context of the invention, the plant species-soil interaction is of particular importance since it allows to improve the effectiveness of the immune response of the plant variety following the application of one or more natural formulations. The soil of the cultivated area is a full-fledged biotope within which exchanges take place constantly with the roots of the plant variety, the soil provides nutrients and in return the microorganisms feed on the root exudates. A high level of biological life in the soil allows it to act as a suppressor of biotic and abiotic stress.

Thus, for example, the natural formulation adapted to promote growth and stimulate the defense system of the plant variety may comprise microorganisms beneficial to the rhizosphere of known type such as symbiotic microorganisms such as Glomus intraradices, microorganisms allowing to solubilize nutrients and to increase their bioavailability for the roots, microorganisms antagonistic to soil-borne pathogens, elicitor microorganisms (capable of stimulating the plant's defenses by stimulating the root cells), in particular fungi of the genus Trichoderma or bacteria of the genus Bacillus or else Pseudomonas, microorganisms producing hormones stimulating plant growth, prebiotics for example rich in nitrogen, carbon and are selected to be metabolized only by target microorganisms (by targeting for example enzymatic activities specific to microbial communities of interest), such as simple sugars, amino acids, algae extracts, or else humic acids, biostimulating substances having positive effects on the growth and general vigor of the plant, such as for example plant extracts, amino acids of animal origin, extracts of degraded organic matter and having the capacity to stimulate germination and root and/or leaf growth (directly or indirectly).

As an alternative or in addition, the natural formulation adapted to stimulate the defense system of the plant variety may comprise Natural Defense Stimulators adapted to activate the defense system of plants, such as the elicitor compounds mentioned previously, but also extracts of plant, animal or microbial origin mimicking a fungal attack by activating the plant's membrane receptors, purified plant extracts stimulating the plant by acting directly in the cascades of metabolic reactions mimicking the elicitation reaction.

Finally, the natural formulation adapted to prevent the development of a pest can generally comprise any substance having an unfavorable impact on the development of the pest in question. By way of non-limiting examples, said natural formulation may comprise an antigerminative substance such as copper, an alcoholic extract of algae (Cai J, Feng J, Xie S, Wang F, Xu Q (2014) Laminaria japonica Extract, an Inhibitor of Clavibater michiganense Subsp. PLOS ONE 9(4): e94329), essential oils (Maryam Zamani-Zadeh and al. (2013) Biocontrol of Gray Mold Disease on Strawberry Fruit by Integration of Lactobacillus plantarum A7 with Ajwain and Cinnamon Essential Oils; Journal of Food Science Vol. 78, No 10), or a substance suitable for creating a barrier effect such as a plant substance or a mineral substance such as talc or kaolin.

Thus, in a preferred embodiment of the method according to the invention:
the first natural formulation comprises microorganisms capable of forming a mutualistic interaction with the plant variety, and preferably a microorganism also acting as an elicitor,
the second natural formulation comprises at least one elicitor coming from a microorganism, for example a bacterium, a virus, or an insect, a nematode, plant fractions or extracts, and/or
the third natural formulation comprises at least one active compound having at least one of the following properties: antibacterial, antiviral, insecticidal, insect repellent, nematicidal, antigerminative, or antifungal property.

Furthermore, when the recommendation comprises the application of the second and third natural formulations, the second natural formulation is applied before the third natural formulation. Indeed, as mentioned previously, one of the objectives of a method according to the invention is to provide a treatment plan allowing to prevent the appearance or development of pests. Thus, the application of a natural formulation directly targeting the pest will preferably be used as a last resort. Therefore, the development of immunity of the plant variety of the cultivated area S1 will be preferred before the application of the third natural formulation, and it will be possible, if necessary, to preferably use a third natural antigerminative formulation.

In one embodiment of the method according to the invention, it may further comprise a step of calculating 550 an amount of the other natural formulation to be applied depending on the prior treatment with the formulation, the values of the parameters of the cultivated area and the value of the environmental parameter. The amount of the other natural formulation may further be recorded in the data repository and be encoded in the generated treatment recommendation.

In another embodiment of the invention, the generation method 1 comprises a display step 600 of at least one treatment recommendation of the cultivated area S1. For example, the treatment recommendation may be in the form of a message displayable by a man-machine interface of a type known to the computer device.

Alternatively or in addition, the generation method 1 may comprise a step of applying (not shown in the figures) the recommended natural formulation(s), by a user. The application step can be a foliar or ground application such as those described above.

### Example of Representation of a Data Repository

As described previously, the parameters of the cultivated area, the environmental parameters and possibly one or more predetermined thresholds can be comprised in a data repository. The table below show an example of representation of a data repository according to the invention.

TABLE 1

| Parameters of the | | | | | | | | | |
|---|---|---|---|---|---|---|---|---|---|
| cultivated area | | | | | | | | | |
| Plant species: | | | | | | | | | |
| Solarium tuberosum | | | Environmental parameter | | | | | | |
| Allians variety | | | Measured and/ | | | | | | |
| Plant variety | | | or forecast | | | | | | |
| development | Varietal | Natural | average | | | | | | Recommended |
| index (stage | resistance | formulation | precipitate | | Period | | | | natural |
| BBCH) | index | applied | level (in mm) | | of time | | Threshold(s) | | formulation |
| 1 | 7 | Foliar | 4 | mm | 3 | days | >5 | mm | 1 - Foliar |
| | | elicitor | | | | | | | elicitor |
| 2 | 7 | n.a | 12 | mm | 4 | hours | >20 | mm | 1 - substance |
| | | | | | | | | | with barrier |
| | | | | | | | | | effect |

| n.a | 8 | mm | 3 | days | ]0 mm-5 mm] | | 1 - Foliar |
|---|---|---|---|---|---|---|---|
| | | | | | | | elicitor |
| | | | | | ]5 mm-10 mm] | | 1 - Foliar |
| | | | | | | | elicitor |
| | | | | | | | 2 - anti- |
| | | | | | | | germinative |
| | | | | | | | 3 - barrier |
| | | | | | | | effect |
| | | | | | | | substance |
| | | | | | ]10 mm-20 mm] | | 1 - anti- |
| | | | | | | | germinative |
| | | | | | | | 2 - Foliar |
| | | | | | | | elicitor + |
| | | | | | | | anti- |
| | | | | | | | germinative |
| | | | | | | | 3- anti- |
| | | | | | | | germinative |
| n.a | 5 | mm | 5 | days | >20 | mm | 1 anti- |
| | | | | | | | germinative + |
| | | | | | | | antifungal |

Table 1 shows an example of a data repository accessible by, or stored in memory in, the computer device. In this example, the parameters of the cultivated area comprise a prior treatment with a natural formulation of foliar elicitor type, carried out during the leaf development phase (BBCH index=1).

As mentioned previously in connection with the comparison step 400 and as presented in Table 1, depending on the development index of the plant variety and the considered environmental parameter, one or more thresholds can be predetermined. In these examples, the thresholds are characterized by value intervals, for example] 0 mm-5 mm], or limit values, for example >20 mm. Each threshold is associated with one or more natural formulations. The value of the considered environmental parameter is compared to the threshold(s) and the threshold comprising the value of the environmental parameter is selected.

As an illustrative example, in Table 1, the plant species Solanum tuberosum, Allians variety, is in the secondary shoot formation/tillering phase (see value “2”), a plurality of values of an environmental parameter has been loaded into the data repository. These different values correspond to averaged measurements of the precipitation level over predetermined periods of time. It can thus be seen that for each predetermined period of time, that is to say 4 hours, 3 days and 5 days, the average precipitation level was calculated. For each period of time, the average value of the precipitation level is then compared to the associated threshold(s). In the example presented, the measured average precipitation level of 8 mm for a period of time of 3 days is the only value which corresponds to one of the determined thresholds, in this case the threshold] 5 mm-10 mm]. Thus, the threshold] 5 mm-10 mm] is selected and the following step of the method can be implemented.

Indeed, as presented in Table 1, each threshold can be associated with at least one predetermined natural formulation. In particular, when the forecast environmental parameter corresponds to the forecast average precipitation level, over a 4-hour period, and the latter is greater than a threshold of 20 mm, a natural formulation of the barrier effect substance type is selected.

In the example presented in connection with the measured average precipitation level of 8 mm, the threshold] 5 mm-10 mm] which is associated with three distinct natural formulation recommendations is selected. By default, the recommendation will include the natural formulation noted “1”, in this case a foliar elicitor. The natural formulation noted “1” is normally selected when the cultivated area has not been subject to the application of a natural formulation during the germination phase. On the other hand, when the cultivated area has been subject to the application of a natural formulation, in this case a foliar elicitor, the recommendation can be modified so that it comprises the natural formulation noted “2”, in this case an antigerminative.

Furthermore, depending on the different phenological stages of the plant variety (BBCH stage), a recommendation may comprise the application of an input. Indeed, as detailed previously, the parameters of the cultivated area S1 can comprise pedological parameters or else nutritional parameters. These parameters can be monitored during the development of the cultivated area S1 and like the environmental parameter described in connection with the average precipitation level measured, other thresholds can be associated with soil or nutrient parameters.

Furthermore, when the cultivated area parameter comprises a type of irrigation (not shown in Table 1). For example, for spray type irrigation, at a predetermined flow rate, the average amount of water delivered during the predetermined period of time (for example 4 hours, 3 days and/or 5 days) can be calculated and added to the measured and/or forecast precipitation level in order to generate an average of the measured and/or forecast precipitation level and the amount of water delivered. When it is the forecast or measured and forecast level of precipitation that is determined, the recommendation can be modified so that it comprises the natural formulation noted “3”, in this case a substance with a barrier effect. Although the level of precipitation and/or the average amount of water delivered by spraying can favor the development of certain pests, other environmental parameters can be taken into account in addition, such as the humidity level and/or temperature.

As already mentioned previously, one of the purposes of the invention is to prevent the appearance or development of pests while eliminating the use of chemical pesticides. For this purpose, the different natural formulations applied preferably have a complementary mode of action in order to provide protection equivalent to a chemical pesticide commonly used as part of the treatment of a predetermined pest.

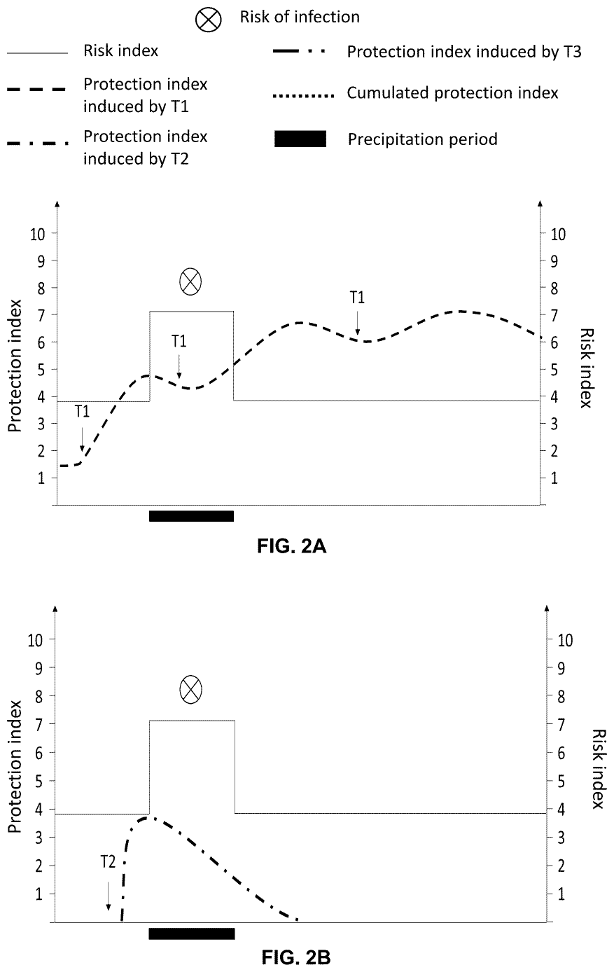

FIG. 2 illustrate the level of protection obtained by four treatments in a given simplified situation. In this simplified situation, a period of precipitation leads to an increase in the level of infection risk over the precipitation period (moving from a level <4 to a level >7) then the risk of infection returns to its initial level (<4) at the end of the precipitation period. This situation does not reflect the complexity of phytopathogenic systems but allows to illustrate in a simplified manner the benefits of the present invention.

The four treatments illustrated in FIGS. 2A to 2D are respectively a treatment based exclusively on eliciting agents (FIG. 2A); a treatment based on an antigerminative agent (FIG. 2B); a treatment based on a curative agent (FIG. 2C); and a treatment according to the invention including a combined and sequenced use of eliciting agents, antigerminative agents and curative agents (FIG. 2D). The level of protection of each treatment (based on a natural formulation) is expressed on a basis of 10. Here, the first treatment T1 includes the use of a first natural formulation 51 to promote growth and stimulate the defense system and was applied when planting seedlings of the plant species Solanum tuberosum, Allians variety. The first natural formulation is a root elicitor, in this case the Gaia Sol® formulation, which has an effectiveness of approximately 30% for a period of approximately 42 days. The first treatment T1 may also include the use of a second natural formulation 52 adapted to stimulate the defense system of the plant variety and is a foliar elicitor, in this case the Milvax® formulation, and is selected according to its complementary biological mode of action of the root elicitor, here the Gaia Sol® formulation. This improves effectiveness against potato late blight by up to approximately 50% compared to Infinito® fungicide. The second natural formulation can be applied at regular intervals to maintain protection for a given period of time. FIG. 2A illustrates that this treatment alone, even repeated, does not allow to achieve a level of protection greater than the level of risk, particularly during periods of precipitation.

The second treatment T2 is usually applied before a precipitation period. Based on an antigerminative, it allows, for example, to prevent the development of a fungal infection and to protect the plant in the event of an increased risk of infection caused by precipitation. However, on its own it appears to be insufficient to ensure a sufficient level of protection in the long term.

The third treatment T3 is usually applied after a precipitation period. It is particularly useful when identifying an infection or a high infection risk situation for a plant. Based on a curative agent, for example antifungals, it allows, for example, to treat a fungal infection. Likewise, on its own it appears to be insufficient to ensure a sufficient level of protection in the long term.

On the other hand, as presented in connection with FIG. 2D, the combination of an elicitor type treatment T1 combined with an antigerminative type treatment T2 and followed by a curative type treatment T3 allows to obtain a cumulative protection index higher than the sum of treatments T1, T2 and T3 taken alone. Thus, over a given period of time, the combination of these treatments allows to obtain a higher protection than the infection risk index of a crop, limiting or even preventing the development of a phytopathogen without resorting to pesticides or chemical antifungals.

The values relating to the effectiveness of natural formulations are presented for illustrative purposes and may vary depending on the combination of natural formulations used, the values of the parameters of the cultivated area, in particular the conditions of the cultivated area in relation to the pedological and/or nutritional parameters.

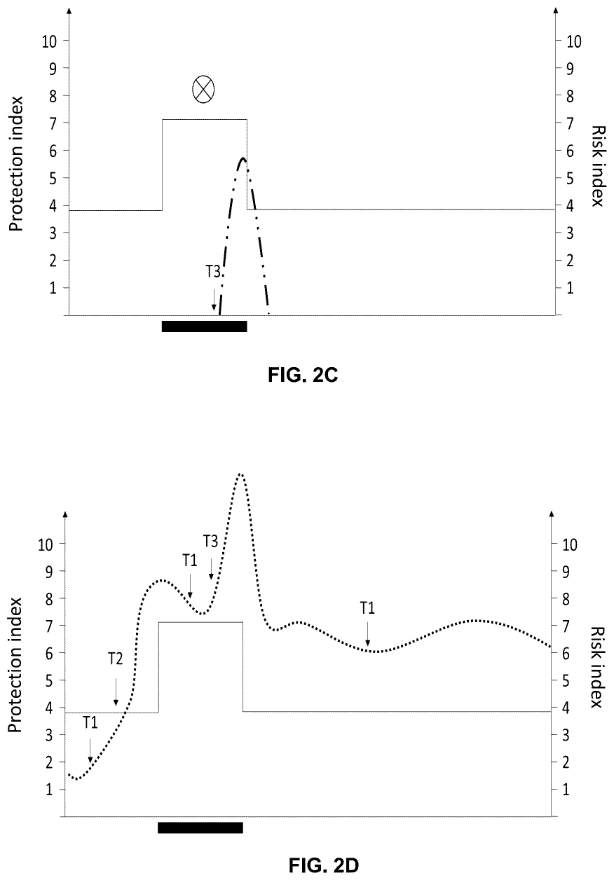

According to a second aspect, and as described in connection with FIG. 3, the invention relates to a system 2 for monitoring a cultivated area S1 and generating a treatment plan adapted for the development of the cultivated area S1, the cultivated area S1 including a first natural formulation 51 adapted to promote growth and stimulate the defense system of a plant variety, the system 2 comprising a computer device 10 and at least one measuring device 20.

Generally speaking, the first natural formulation 51 may further comprise a root elicitor and/or an antagonist of soil-borne pathogens. More particularly, the first natural formulation 51 may comprise microorganisms or elicitors derived from plant extracts, a fertilizer derived from the decomposition of organic waste by earthworms, and/or chitin or one of its derivatives, such as chitosan.

Preferably, the first natural formulation 51 comprises at least one root elicitor. Without limitation, the first natural formulation 51 comprises an extract of marine algae, in particular an alcoholic extract of one or more brown, green and/or red algae, for example Ascophyllum nodosum, a fish meal hydrolyzate, a bacterium of the Bacillus amyloliquefaciens type, a fungus of the Trichoderma harzianum type and/or humic and fulvic acids.

As illustrative examples, the computer device 10 can be a smartphone or a connected tablet and configured to communicate via a wireless communication network with the measuring device 20.

In a particular embodiment of the system according to the invention, the measuring device 20 can be a weather station of known type. The weather station, or more generally the measuring device 20, may comprise one or more sensors of known type adapted to measure one or more environmental parameters as mentioned above.

Alternatively or in addition, the measuring device 20 can also be adapted to measure a detection of a pathogenic organism or a detection of a pathological symptom on the plant variety. For example, the measuring device 20 may comprise one or more spore sensors of known type placed in the cultivated area S1.

Thus, depending on the environmental parameters of interest, a system according to the invention may comprise a plurality of sensors positioned in or near the cultivated area S1.

In the invention, the measuring device 20 is adapted to measure at least one environmental parameter P2S1 of the cultivated area S1.

Furthermore, the measuring device 20 can be configured to perform measurements at regular intervals, for example every hour, and to communicate the measurements to the computer device 10.

Still in the invention, the computer device 10 is configured to:
load parameters P1S1 of the cultivated area S1, said parameters comprising at least one plant variety, a varietal resistance index associated with the plant variety and a development index of the plant variety,
load at least one value of an environmental parameter P2S1, for a predetermined past period of time, from the cultivated area S1,
determine at least one threshold, for the considered environmental parameter, depending on the plant variety, the varietal resistance index and the development index of the plant variety,
compare the value of the environmental parameter P2S1 to the at least one determined threshold and select the threshold corresponding to the value of the environmental parameter.

In addition, the parameters P1S1 of the cultivated area S1 may comprise a prior treatment with a natural formulation for a given period of time, geographic coordinates of the cultivated area S1 and/or a type of irrigation.

The value of the environmental parameter P2S1 of the cultivated area S1 can be communicated directly to the computer device 10 or to the remote server 40, in particular when said value comes from a measurement carried out by a measuring device 20 positioned in or near the cultivated area S1. However, it is expected that certain environmental parameter values may come from a third-party remote server 30.

Furthermore, the parameters P2S1 of the cultivated area S1 can be recorded on a remote server 40 or directly in the computer device 10.

In addition, the remote servers 40 and third parties 30 can communicate with each other, in particular by sending a message comprising the value of the environmental parameter P2S1. In all cases, the remote servers 40 and third parties 30 are configured to communicate with the computer device 10 to which the value of the environmental parameter P2S1 and the parameters P1S1 of the cultivated area S1 are sent.

In the invention, the computer device 10 is further configured to generate a recommendation R1, R2 for treatment of the cultivated area S1 based on the selected threshold, said recommendation R1, R2 including the application of at least one other natural formulation 50 selected from:
a second natural formulation 52 adapted to stimulate the defense system of the plant variety, and/or
a third natural formulation 53 adapted to prevent the development of a pest.

For example, the second natural formulation 52 may comprise a foliar elicitor. More particularly, the second natural formulation 52 may comprise a decoction of field horsetail, clove (Syzygium aromaticum), nettle (Urtica dioica), an extract of tea tree (Camellia sinensis), soy lecithin, sunflower oil and guar gum (Cyamopsis tetragonolobus).

Furthermore, the third natural formulation 53 may comprise a substance called “intervention” substance such as antigerminative, curative substances, for example a natural fungicide, with a barrier effect, and/or a natural biocide.

By way of example, the third natural formulation 53 may comprise a decoction of field horsetail, Chinese cinnamon (Cinnamomum aromaticum), clove (Syzygium aromaticum), common eucalyptus (Eucalyptus globulus), soy lecithin, sunflower oil and/or guar gum (Cyamopsis tetragonolobus), or a solution based on copper sulfate and plant extracts.

When similar examples are given for different natural formulations, the action of the compounds as an elicitor, antigerminative or curative is dependent on the concentration, generally known to the person skilled in the art, at which these compounds are applied.

According to a third aspect, the invention relates to a method for treating an area S1 cultivated for a predetermined period of time. The treatment method comprises a first treatment of the cultivated area S1, a second treatment of the cultivated area S1 and a third treatment of the cultivated area S1.

By way of non-limiting example, the predetermined period of time may correspond to the development of the cultivated area from the planting of a predetermined plant species, of the cultivated area until the harvest of the plant species and/or of its fruits.

In the method for treating a cultivated area S1 according to the invention, the first treatment of the cultivated area S1 is implemented at a first instant of the predetermined period of time.

Preferably, the first instant of the predetermined period of time may correspond to a step of development of the cultivated area, more particularly of a predetermined plant species. In particular, the first instant of the predetermined period of time may correspond to a stage of development as defined by the BBCH code mentioned above. More particularly, the first instant of the predetermined period of time may correspond to the stage of development corresponding to the planting.

In the context of the invention, the first treatment of the cultivated area S1 includes at least one root and/or foliar application of a natural formulation comprising an agent that elicits defense reactions.

As illustrative examples, when the first treatment of the cultivated area S1 includes a root application, this can be carried out by coating or dip treating the seeds or via a soil irrigation technique of known types or else by spraying as mentioned previously. Preferably, when the first treatment of the cultivated area S1 includes a root application, the agent that elicits defense reactions may comprise one or more elicitors. Without this being limiting, the agent that elicits defense reactions may comprise an extract of marine algae, for example Ascophyllum nodosum, an animal extract suitable for inducing elicitation, such as chitosan, a fish meal hydrolyzate, one or more microorganisms adapted to induce elicitation such as a bacteria of the genus Bacillus, for example Bacillus amyloliquefaciens, a fungus of the genus Trichoderma, such as Trichoderma harzianum and/or humic and fulvic acids.

Furthermore, when the first treatment of the cultivated area S1 includes a foliar application, this can for example be an application by spraying, that is to say the projection of a composition in the form of drops, droplets or even aerosol by a spraying device of known type, a mounted, semi-mounted or self-propelled sprayer towed or dragged by a motorized vehicle such as a tractor for example, but also by aerial spreading, such as by plane or helicopter or else via the use of drones, which are autonomous or not. Preferably, when the first treatment of the cultivated area S1 includes a foliar application, the agent that elicits defense reactions may comprise one or more elicitors. Without this being limiting, the agent that elicits defense reactions may comprise a decoction of field horsetail, clove (Syzygium aromaticum), nettle (Urtica dioica), an extract of tea tree (Camellia sinensis), soy lecithin, sunflower oil and/or guar gum (Cyamopsis tetragonolobus).

Alternatively or in addition, when the first treatment of the cultivated area S1 includes a root or foliar application, the agent that elicits defense reactions may comprise lipopeptides from microorganisms.

In order to best stimulate the defense system of the plant species of the cultivated area S1, the first treatment of the cultivated area S1 is carried out at least twice at least 5 days apart.

Preferably, when the first treatment of the cultivated area S1 includes a root application, the first treatment of the cultivated area S1 can be carried out at least twice at least 15 days apart and at most 90 days apart.

Furthermore, when the first treatment of the cultivated area S1 includes a foliar application, the first treatment of the cultivated area S1 can be carried out at least twice at least 5 days apart and at most 60 days apart.

In addition, the first treatment of the cultivated area S1 can be implemented at regular intervals, as described previously, until the stage of development ranging from the start of senescence until the time of harvest of the plant species of the cultivated area S1 and/or its fruits.

In the method for treating a cultivated area S1 according to the invention, the second treatment of the cultivated area S1 is implemented at a second instant of the predetermined period of time.

Preferably, the second instant of the predetermined period of time may correspond to the occurrence of a forecast precipitation episode. The occurrence of a forecast precipitation episode can be characterized by a forecast environmental parameter. The forecast environmental parameter can describe a forecast average precipitation level at a given future date and for a predetermined duration.

Still in the method for treating a cultivated area S1 according to the invention, the second treatment includes the application of a natural formulation comprising an antigerminative.

By way of non-limiting examples, the antigerminative may comprise copper, an alcoholic extract of algae with antigerminative properties, one or more essential oil(s) adapted to induce an antigerminative effect at a predetermined concentration, for example cloves, cinnamon, flowering plants of the tea tree genus, mint, eucalyptus, thyme or oregano, or else a substance suitable for creating a barrier effect such as a plant substance, or a mineral substance for example from lithothamne, talc or kaolin.

Preferably, the natural formulation comprising an antigerminative is applied to all or part of the plant species of the cultivated area S1, more particularly on the leaf part of the plant species of the cultivated area S1.

Still in the invention, the second natural formulation is applied less than two days before the occurrence of a forecast precipitation episode if the forecast precipitation level is greater than a predetermined threshold. Indeed, the purpose of the natural formulation comprising an antigerminative is to prevent the possible development of a pathogen which could be favored following the occurrence of more or less significant precipitation. Depending on the plant species of the cultivated area, a threshold characterizing a level of precipitation favoring the development of pathogens can be predetermined and a level of precipitation greater than this threshold can trigger the implementation of the second treatment.

In the method for treating a cultivated area S1 according to the invention, the third treatment of the cultivated area S1 is implemented at a third instant of the predetermined period of time.

Preferably, the third instant of the predetermined period of time may correspond to the end of a precipitation episode.

Still in the method for treating a cultivated area S1 according to the invention, the third treatment includes the application of a natural formulation comprising a curative agent, for example a natural fungicide.

By way of non-limiting examples, the curative agent may comprise an active compound having at least one of the following properties: antibacterial, antiviral, insecticidal, insect repellent, nematicide or antifungal property.

Preferably, the natural formulation comprising a curative agent is applied to all or part of the plant species of the cultivated area S1, more particularly on the leaf part of the plant species of the cultivated area S1.

Still in the invention, the natural formulation comprising a curative agent is applied less than two days after the end of the forecast precipitation episode. Indeed, the purpose of the natural formulation comprising a curative agent is to physically damage the pathogen once it has infected the plant species of the cultivated area S1. Depending on the plant species of the cultivated area, the curative agent may comprise one or more essential oil(s), one or more microorganisms, one or more plant extracts, or algae. In particular, all or part of the components disclosed in connection with the second treatment, more particularly those having an antigerminative action, can be used as a curative agent. However, their use as a curative agent will be subject to a suitable concentration, as is known to the person skilled in the art, generally much higher, to deliver a curative effect, than to deliver an antigerminative effect.

In one embodiment of a method for treating a cultivated area S1 according to the invention, said method may comprise a step of controlling the soil of the cultivated area S1.

The control step may comprise measuring the following parameters: a cation exchange capacity, a hydrogen potential, an organic matter content, a carbon to nitrogen mass ratio and a microbial biomass content.

Depending on values of the measured parameters, the first, second and third treatments can be implemented if said values meet respective predetermined criteria.

As illustrative examples, the first, second and third treatments are implemented when the measured value of the cation exchange capacity is comprised between 9 and 16 meq/100 g, preferably between 14 and 16 meq/100 g, the measured value of the organic matter content is comprised between 1.1% and 2.7%, the measured value of the hydrogen potential is comprised between 6.8 and 7.5, the value of the carbon to nitrogen mass ratio measured is comprised between 8 and 12, and the value of the measured microbial biomass content is greater than or equal to 200 mg C_{microbial}/kg soil.

Optionally, each of the first, second and third treatments can be comprised in a treatment recommendation generated by a method 1 for generating a treatment plan according to the invention.

According to a fourth aspect, the invention relates to a machine learning model trained to predict a treatment plan adapted for the conditions of development of a cultivated area S1 including a first natural formulation adapted to promote growth and stimulate the defense system of a plant variety.

The general principle of the machine learning model trained according to the invention is based on the observation of correlations between the development of a pest based on environmental parameters. Thus, by measuring the effectiveness of the treatment of a plant variety with one or more natural formulations applied, compared to a known chemical pesticide, against a predetermined pest, it is possible to determine a treatment plan. Subsequently, this treatment plan can be used to eliminate the use of the chemical pesticide commonly used against the pest.

In the invention, the trained machine learning model is a model called predictive model in which significant correlations are discovered in a set of past observations and in which it is sought to generalize these correlations to cases not yet observed. As such, the machine learning model trained according to the invention is distinguished from models called explanatory models in which it is sought to understand the causal mechanism underlying the phenomenon to be predicted. Furthermore, the machine learning model trained according to the invention is obtained using an approach called supervised learning approach in which past observations are “labeled”. In practice, observations are said to be “labeled” when each of them is accompanied by a label which identifies the phenomenon to be predicted. Training the machine learning model according to the invention requires a plurality of reference cultivated areas, for which environmental parameters are measured, via suitable measuring devices, such as those described above.

The system according to the invention being intended to be used by numerous farmers/users and therefore numerous cultivated areas, the amount of data analyzed represents a relevant source of information for the continuous improvement of the learning model.

Generally speaking, the presence or absence of a pest following the application of predetermined natural formulations is crucial information to validate the relevance or to correct the recommendations generated.

It is thus possible to propose numerous variations of recommendations for the same plant variety and for similar environmental conditions, for example with earlier or later use of this or that natural formulation.

In particular, if several less safe treatment data, that is to say which comprise a limited number of applications of natural formulations, result in the absence of triggering of a disease (absence of pest) on a given plant variety, it could be considered that these more economical treatment data are sufficient and will be used to generate a recommendation.

Likewise, if the first treatment data leads to the presence of pests, and the second treatment data allows to go through the risky episodes without the development of pests, the learning model can be configured to reference the second treatment data as the new standard and thus include them when generating a recommendation.

Still in the invention, the trained machine learning model is obtained according to the following steps:
acquiring, at each of the acquisition instants of a plurality of successive acquisition instants, reference parameter values of a plurality of reference cultivated areas, the reference parameters comprising, for each reference cultivated area, at least:
   parameter values of the cultivated area, the parameters of the cultivated area including a plant variety, a varietal resistance index associated with the plant variety, a development index of the plant variety,
   a value of an environmental parameter,
   processing data including at least one other natural formulation selected from a second natural formulation adapted to stimulate the defense system of the plant variety, and/or a third natural formulation adapted to prevent the development of a pest, and
   data on the effectiveness of the treatment with the at least one other natural formulation.

In the learning model according to the invention, the successive acquisition instants are spaced from each other by a predetermined duration, for example 1 hour.

In the learning model according to the invention, the effectiveness data can indicate the absence of development of a predetermined pest.

Alternatively, when the value of the environmental parameter corresponds to the detection of a predetermined pest, the effectiveness data can indicate a degree of effectiveness of the treatment compared to a chemical pesticide commonly used against said pest.

The trained machine learning model is also obtained according to a step of:
calculating, at each acquisition instant, for each of the plurality of reference cultivated areas, mathematical quantities, from the values of the parameters of the cultivated area, the value of the associated environmental parameter, acquired at acquisition instants comprised in a predetermined period of time preceding the current acquisition instant.

In an example of the calculation step, the mathematical quantities are obtained from a mathematical function selected from: square root, power, logarithm, exponential, gradient, average or a combination thereof. However, other mathematical functions can be considered.

In another example, the predetermined period of time may be 4 hours, 1 or more days, one or more weeks.

Then, the trained machine learning model is obtained according to the steps of:
creating, for each of the plurality of reference cultivated areas, a mathematical reference function, for example describing a reference vector, from the parameter values of the cultivated area, the value of the environmental parameter and the mathematical quantities,
associating, at each acquisition instant, for each of the plurality of reference cultivated areas, the mathematical reference function, for example describing the reference vector, with the efficiency data of the treatment of the reference cultivated area, so as to obtain machine learning model variables, and
training a machine learning model to predict a treatment plan including at least one other natural formulation, based on a machine learning algorithm and machine learning model variables.

In the training step, training the machine learning model is carried out by providing the machine learning model with a set of training data in the form of pairs (X, Y), in which X corresponds to a set of predictive variables and Y corresponds to a predicted variable. In practice, a pair (X. Y) is defined such that the predictive variable X comprises the characteristic mathematical function, for example the characteristic vector, of the machine learning model variables and the predicted variable Y comprises the processing data including the natural formulation(s) used to treat the reference cultivated area, the first machine learning model variables which are associated with the predetermined period of time.

In an example of the learning step, the machine learning algorithm is based on the random forest method. However, other supervised type regression machine learning algorithms can also be considered.

The invention may be the subject of numerous variants and applications other than those described above. In particular, unless otherwise indicated, the different structural and functional characteristics of each of the implementations described above should not be considered as combined and/or closely and/or inextricably related to each other, but on the contrary as simple juxtapositions. Furthermore, the structural and/or functional characteristics of the different embodiments described above may be the subject in whole or in part of any different juxtaposition or of any different combination.

The description which has just been made of the invention has been detailed so that a person skilled in the art, having ordinary skills in the art can, using the preceding description and the following illustrative examples, make and use the products of the present invention and practice the claimed methods.

### Examples

The invention is described in more detail below with reference to the following experimental examples. These examples are provided for illustrative purposes only and are not intended to be limiting unless otherwise noted. Thus, the invention should in no way be interpreted as being limited to the following illustrative examples, but rather should be interpreted as encompassing all variations which become evident as a result of the teaching provided herein.

Potato. Comparison of a Treatment Plan According to the Invention with a Conventional Treatment Plan

Two secure plots for a total of approximately 5 ha planted with the ‘GOURMANDINE’ potato variety, a variety known to be sensitive to foliage mildew, were used.

For 2 months, a treatment plan according to the invention was applied on a first plot including one or more applications of root elicitor, foliar elicitor, micronutritions, antifungal based on natural active ingredients and preventative copper-based antifungal.

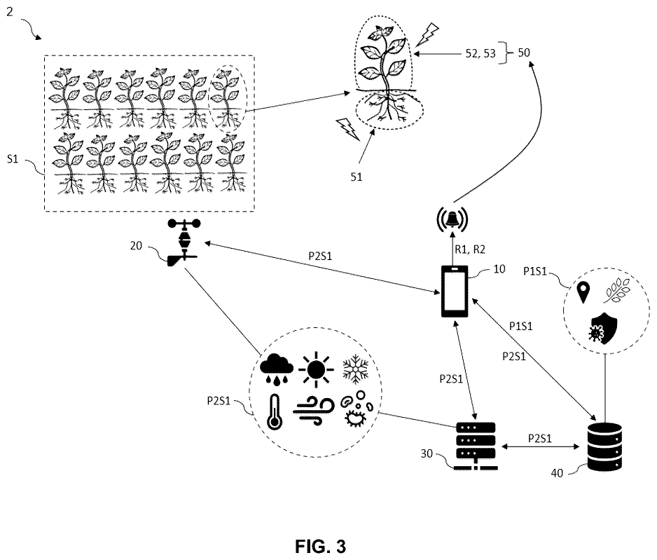

In particular, a treatment plan is illustrated in FIG. 4. This treatment plan is implemented on a cultivated area subject over the period to several periods of precipitation exceeding 20 mm/m² (volume of precipitation indicated in millimeters of precipitation per square meter—indicated by crosses in FIG. 4). Also over the period studied, the cultivated area was subject to pressure by a fungal pathogen, the level of which is quantified through the measurement of the spore reserve (histogram in FIG. 4).

As illustrated, a treatment plan according to the invention includes several repetitions of first treatment T1 with for example the use of a first natural formulation 51. This first treatment is repeated several times during the cultivation period and can also include the use of a second natural formulation 52 adapted to stimulate the defense system of the plant variety. Furthermore, in accordance with the invention, the treatment plan includes several second treatments T2 of the cultivated area including a natural formulation comprising an antigerminative, this natural formulation being applied before the occurrence of a forecast precipitation episode. Also, in particular when spores appear, the plan includes several third treatments based on a third natural formulation comprising a curative agent and generally applied after a rainy episode. Finally, the treatment plan advantageously includes fourth micronutrition treatments T4 including the application of trace elements and amino acids, mainly in the form of algae or plant extracts or an input as mentioned previously.

For 2 months, on a second plot, a conventional treatment plan was applied including one or more applications of mancozeb, mandipropamide, fluopicolide, valifenalate, chlorantraniliprole and cymoxanil.

Thus, the plot conducted according to the treatment plan according to the invention did not receive fungicide treatment of chemical origin. Only plant defense stimulators and natural active ingredients were used. The total amount of copper metal used is 1.25 kg/ha.

Concerning the plot conducted with a conventional treatment plan, there were 12 fungicide treatments as well as 3 insecticides. The treatment frequency index is therefore relatively high, as is the impact on people and the environment.

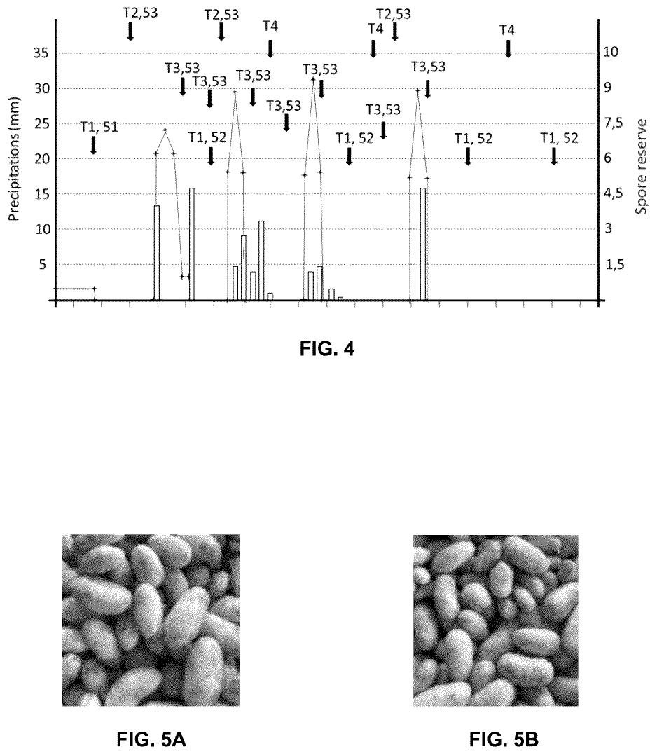

Despite the high pressure of the pathogen from the end of May to the beginning of July, the yields obtained with the treatment plan according to the invention are similar to those obtained with conventional management with a yield of 30 t/ha for the plot conducted under the conventional treatment plan, part of the harvest of which is shown in FIG. 5B, and 31 t/ha for the plot conducted in a treatment plan according to the invention, part of the harvest of which is shown in FIG. 5A.

Thus, the treatment plan combining elicitor treatment, micronutrition, preventive antifungal and antifungal based on natural active ingredients according to environmental conditions allows to achieve sufficient levels of protection to obtain an expected yield with a lesser impact on the environment and health.

Zucchini. Comparison of a Treatment Plan According to the Invention with a Conventional Treatment Plan

Two secure plots for a total of around 10 ha planted with zucchini.

For 2 months, on a first plot, a treatment plan according to the invention was applied including one or more applications of root elicitor agent, foliar elicitor, micronutrients, and antifungal based on natural active ingredients.

For 2 months, on a second plot, a conventional treatment plan was applied including one or more applications of mancozeb, mandipropamide, fluopicolide, valifenalate, chlorantraniliprole, and cymoxanil.

Thus, the plot conducted according to the treatment plan according to the invention did not receive fungicide treatment of chemical origin. It has received 10 rounds of treatment with formulations based on natural substances. Concerning the plot conducted with a conventional treatment plan, there were 6 passes of fungicide and/or insecticide treatments.

The yields obtained with the treatment plan according to the invention are similar to those obtained with conventional conduct. Indeed, the yield obtained is 100 t/ha for the plot conducted under a conventional treatment plan and also 100 t/ha for the plot conducted under a treatment plan according to the invention.

Thus, the treatment plan combining elicitor treatment, micronutrition, preventive antifungal depending on environmental conditions allows to achieve sufficient levels of protection to obtain an expected yield with a lesser impact on the environment and health.

The invention may be the subject of numerous variants and applications other than those described above. In particular, unless otherwise indicated, the different structural and functional characteristics of each of the implementations described above should not be considered as combined and/or closely and/or inextricably related to each other, but on the contrary as simple juxtapositions. Furthermore, the structural and/or functional characteristics of the different embodiments described above may be the subject in whole or in part of any different juxtaposition or of any different combination.

1. A method for generating a treatment plan adapted for the conditions of development of a cultivated area including a first natural formulation adapted to promote growth and stimulate a defense system of a plant variety, said method being implemented by a computer device, the generation method comprising the following steps:
loading values of parameters of the cultivated area, said parameters comprising at least one plant variety, at least one varietal resistance index associated with the plant variety and a development index of the plant variety,
loading at least one value of an environmental parameter, for a predetermined past period of time, of the cultivated area,
a loading at least one value of a forecast environmental parameter, for a predetermined future period of time, of the cultivated area from geographical coordinates of said cultivated area, the at least one value of the environmental parameter comprising a precipitation level,
generating a treatment recommendation for the cultivated area according to the at least one value of the environmental parameter, the at least one value of the forecast environmental parameter and the values of the parameters of the cultivated area, said recommendation including:
a first treatment of the cultivated area at a first instant of the predetermined future period of time, said first treatment including at least one root and/or foliar application of a second natural formulation comprising an agent that elicits defense reactions; said first treatment being carried out at least twice at least 5 days apart;
a second treatment of the cultivated area, at a second instant of the predetermined future period of time, said second treatment including the application of a third natural formulation comprising an antigerminative, the third natural formulation comprising the antigerminative being applied less than two days before an occurrence of a forecast precipitation episode if the forecast precipitation level is greater than a predetermined threshold,
a third treatment of the cultivated area at a third instant of the predetermined future period of time, said third treatment including the application of a fourth natural formulation comprising a curative agent, the fourth natural formulation comprising the curative agent being applied less than two days after an end of the forecast precipitation episode.

2. The generation method according to claim 1, wherein said loading at least one value of an environmental parameter is followed by the steps of:
determining at least one threshold, for the respective environmental parameter, according to the values of the parameters of the cultivated area,
comparing the value of the respective environmental parameter to the at least one determined threshold and selecting the threshold corresponding to the value of the respective environmental parameter, and
wherein generating the recommendation for treating the cultivated area is based on the selected threshold.

3. The generation method according to claim 1, wherein the parameters of the cultivated area further comprise pedological parameters, nutritional parameters, a prior treatment with a further natural formulation and/or a type of irrigation.

4. The generation method according to claim 1, wherein:
the first natural formulation adapted to promote growth and stimulate the defense system of a plant variety is applied via the root, and
the recommendation of the second natural formulation comprises a foliar application.

5. The generation method according to claim 3, further comprising modifying the recommendation generated based on the prior treatment with a natural formulation and/or the type of irrigation.

6. The generation method according to claim 1, wherein the environmental parameter comprises a temperature, a humidity level, a frost risk indicator, a precipitation level, a sunshine level, a wind speed, a detection of a pathogenic organism or a detection of a pathological symptom on the plant variety.

7. The generation method according to claim 3, the further comprising calculating an amount of the second natural formulation to be applied according to the prior treatment with the further natural formulation, the parameters of the cultivated area and the value of the environmental parameter.

8. The generation method according to claim 1, wherein:
the first natural formulation comprises microorganisms capable of forming a mutualistic interaction with the plant variety,
the second natural formulation comprises at least one elicitor coming from microorganisms, an insect, a nematode or plant fractions or extracts, and/or
the third natural formulation comprises at least one active compound having at least one of the following properties: antibacterial, antiviral, insecticidal, insect repellent, antigerminative, nematicidal or antifungal, and
when the recommendation comprises the application of the second and third natural formulations, the second natural formulation is applied before the third natural formulation.

9. The generation method according to claim 3, wherein the parameters of the cultivated area comprise pedological and/or nutritional parameters, said method further comprising comparing at least one value of a soil and/or nutrient parameter to a predetermined threshold and generating a recommendation to add an input when the value of the soil and/or nutrient parameter is not equal to the predetermined threshold.

10. A system for monitoring a cultivated area and generating a treatment plan adapted for the development of the cultivated area including a first natural formulation adapted to promote growth and stimulate a plant variety defense system, the system comprising a computer device and at least one measuring device, in which:
the measuring device is adapted to measure at least one environmental parameter of the cultivated area,
the computer device is configured to:
load values of parameters of the cultivated area, said parameters comprising at least one plant variety, at least one varietal resistance index associated with the plant variety and a development index of the plant variety,
load at least one value of an environmental parameter, for a predetermined past period of time, from the cultivated area,
load at least one value of a forecast environmental parameter, for a predetermined future period of time, of the cultivated area based on geographical coordinates of said cultivated area, the at least one value of the environmental parameter comprising a precipitation level,
generating a treatment recommendation of the cultivated area according to the at least one value of the environmental parameter, the at least one value of the forecast environmental parameter and the values of the parameters of the cultivated area, said recommendation including:
a first treatment of the cultivated area at a first instant of the predetermined future period of time, said first treatment including at least one root and/or foliar application of a second natural formulation comprising an agent that elicits defense reactions; said first treatment being carried out at least twice at least 5 days apart;
a second treatment of the cultivated area, at a second instant of the predetermined future period of time, said second treatment including the application of a third natural formulation comprising the antigerminative, the third natural formulation comprising the antigerminative being applied less than two days before an occurrence of a forecast precipitation episode if the forecast precipitation level is greater than a predetermined threshold,
a third treatment of the cultivated area at a third instant of the predetermined future period of time, said third treatment including the application of a fourth natural formulation comprising a curative agent, the fourth natural formulation comprising the curative agent being applied less than two days after an end of the forecast precipitation episode.

11. A method for treating a cultivated area for a predetermined period of time, said method including:
a first treatment of the cultivated area at a first instant of the predetermined period of time, said first treatment including at least one root and/or foliar application of a second natural formulation comprising an agent that elicits defense reactions; said first treatment being carried out at least twice at least 5 days apart;
a second treatment of the cultivated area, at a second instant of the predetermined period of time, said second treatment including the application of a third natural formulation comprising an antigerminative, the third natural formulation comprising the antigerminative being applied less than two days before an occurrence of a forecast precipitation episode if the forecast precipitation level is greater than a predetermined threshold,
a third treatment of the cultivated area at a third instant of the predetermined period of time, said third treatment including application of a fourth natural formulation comprising a curative agent, the fourth natural formulation comprising the curative agent being applied less than two days after an end of the forecast precipitation episode.

12. The method for treating a cultivated area according to claim 11, further comprises controlling soil of the cultivated area, comprising measurement of the following parameters: a cation exchange capacity, a hydrogen potential, an organic matter content, a carbon to nitrogen mass ratio and a microbial biomass content, the first, second and third treatments being implemented if the values of said measured parameters meet respective predetermined criteria.

13. The method for treating a cultivated area according to claim 11, wherein the first, second and third treatments do not comprise systemic chemical compounds.

14. The method for treating a cultivated area according to claim 11, wherein the second natural formulation comprises at least one agent that elicits defense reactions selected from: a plant extract adapted to induce elicitation at a predetermined concentration, an animal extract adapted to induce elicitation, an algae extract adapted to induce elicitation at a predetermined concentration, a microorganism adapted to induce elicitation or combinations thereof.

15. The method for treating a cultivated area according to claim 14, wherein the plant extract is a horsetail extract or nettle extract or a combination thereof.

16. The method for treating a cultivated area according to claim 14, wherein the animal extract is chitosan.

17. The method for treating a cultivated area according to claim 14, wherein the microorganism adapted for inducing elicitation is selected from the genus Trichoderma, the genus Bacillus or combinations thereof.

18. The method for treating a cultivated area according to claim 11, wherein the third natural formulation comprises at least one antigerminative selected from: a copper-based composition, a mineral substance, an essential oil adapted to induce an antigerminative effect at a predetermined concentration, or combinations thereof.

19. The method for treating a cultivated area according to claim 18, wherein the mineral substance is talc, kaolin, lithothamne, or combinations thereof.

20. The method for treating a cultivated area according to claim 18, wherein the antigerminative is an essential oil selected from an essential oil of clove, cinnamon, flowering plants of the tea tree genus, mint, eucalyptus, thyme, oregano or combinations thereof.

21. The method for treating a cultivated area according to claim 11, wherein the fourth natural formulation comprises at least one curative agent selected from: an essential oil adapted to induce a curative effect at a predetermined concentration, a hydroalcoholic extract of algae or combinations thereof.

22. The method for treating a cultivated area according to claim 21, wherein the curative agent is selected from an essential oil of clove, cinnamon, eucalyptus, thyme or combinations thereof.

23. The method for treating a cultivated area according to claim 21, wherein the curative agent is a hydroalcoholic extract of red algae.

24. The method for treating a cultivated area according to claim 21, wherein the curative agent comprises a microorganism of the genus Bacillus.

25. A machine learning model trained to predict a treatment plan adapted for the conditions of development of a cultivated area including a first natural formulation adapted to promote growth and stimulate the defense system of a plant variety, the trained machine learning model being obtained according to the following steps:
acquiring, at each of acquisition instants of a plurality of successive acquisition instants, values of reference parameters of a plurality of reference cultivated areas, the reference parameters comprising, for each reference cultivated area, at least:
values of parameters of the cultivated area, the parameters of the cultivated area including a plant variety, a varietal resistance index associated with the plant variety, a development index of the plant variety,
a value of an environmental parameter,
processing data including at least one other natural formulation selected from a second natural formulation adapted to stimulate the defense system of the plant variety, and/or a third natural formulation adapted to prevent the development of a pest, and
data on the effectiveness of the treatment with the at least one other natural formulation,
calculating, at each acquisition instant, for each of the plurality of reference cultivated areas, mathematical quantities, from the values of the parameters of the cultivated area, the value of the associated environmental parameter, acquired at acquisition instants included in a predetermined period of time preceding the current acquisition instant,
creating, for each of the plurality of reference cultivated areas, a mathematical reference function from the parameter values of the cultivated area, the value of the environmental parameter and the mathematical quantities,
associating, at each acquisition instant, for each of the plurality of reference cultivated areas, the mathematical reference function with the efficiency data of the treatment of the reference cultivated area, so as to obtain variables of the machine learning model, and
training the machine learning model to predict a treatment plan including at least one other natural formulation, based on a machine learning algorithm and machine learning model variables.
